(19) United States
(12) Patent Application Publication
(10) Pub. No.: US 2015/0322224 A1
(43) Pub. Date: Nov. 12, 2015

(54) A PROCESS FOR REDUCING THE ELECTROSTATIC POTENTIAL OF PERFLUOROELASTOMER ARTICLES

(71) Applicant: E. I. DU PONT DE NEMOURS AND COMPANY, Wilmington, DE (US)

(72) Inventors: Peter Anthony Fox, Wilmington, DE (US); Yoshio Namiki, Tochigi (JP); Shuong Wang, Hockessin, DE (US)

(21) Appl. No.: 14/410,346

(22) PCT Filed: Jun. 27, 2013
(86) PCT No.: PCT/US13/48041

§ 371 Date: Dec. 22, 2014

Related U.S. Application Data
(60) Provisional application No. 61/665,377, filed on Jun. 28, 2012.

(51) Int. Cl. C08J 7/12

(52) U.S. Cl. CPC C08J 7/12; C08J 2327/22; C08J 2329/10

(57) ABSTRACT

This invention is a process for reducing the electrostatic potential of a perfluoroelastomer article wherein a perfluoroelastomer article is treated with a sodium naphthalide solution, washed and treated with ammonium hydroxide.

### FIELD OF THE INVENTION

This invention relates to a process for reducing the electrostatic potential of perfluoroelastomer articles. More specifically, this invention relates to a process wherein the surface of a perfluoroelastomer article is treated with a reducing agent.

### BACKGROUND OF THE INVENTION

Perfluoroelastomers have achieved outstanding commercial success and are used in a wide variety of applications in which severe environments are encountered, in particular those end uses where exposure to high temperatures and aggressive chemicals occurs. For example, these polymers are often used in seals for aircraft engines, in oil-well drilling devices, and in sealing elements for industrial equipment used at high temperatures.

The outstanding properties of perfluoroelastomers are largely attributable to the stability and inertness of the copolymerized perfluorinated monomer units that make up the major portion of the polymer backbones in these compositions. Such monomers include tetrafluoroethylene and perfluorinated vinyl ethers. In order to develop elastomeric properties fully, perfluoroelastomers are typically crosslinked, i.e. vulcanized. To this end, a small amount of cure site monomer is typically copolymerized with the perfluorinated monomer units. Cure site monomers containing at least one nitrile group, for example perfluoro-8-cyano-5-methyl-3,6-dioxa-1-octene, are especially preferred. Such compositions are described in U.S. Pat. Nos. 4,281,092; 4,394,489; 5,789,489; and 5,789,509.

In certain end use applications, such as in semiconductor wafer manufacturing equipment, the relatively high (i.e. >500V) electrostatic potential of a typical perfluoroelastomer article may present problems. It is known that the electrostatic potential may be reduced by incorporation of a conductive filler into the perfluoroelastomer article. However, such fillers may be an undesirable source of contamination in semiconductor wafer manufacturing equipment. Thus, another means of reducing the electrostatic potential of perfluoroelastomer articles would be desirable.

### SUMMARY OF THE INVENTION

An aspect of this invention is a process for reducing the electrostatic potential of a perfluoroelastomer article, said process comprising:

A) treating a perfluoroelastomer article with a reducing agent in order to reduce at least one surface of the perfluoroelastomer article;
B) washing the reduced perfluoroelastomer article to remove any excess reducing agent; and
C) treating the washed, reduced perfluoroelastomer article with an ammonium hydroxide solution.

Another aspect of this invention is an article comprising a cured perfluoroelastomer, said article having an electrostatic potential less than 500V and a weight ratio of fluorine atoms to carbon atoms of 1.3:1 to 0.9:1, as measured by ESCA, and wherein said article is free from conductive carbon black.

### DETAILED DESCRIPTION OF THE INVENTION

Perfluoroelastomers are polymeric compositions having copolymerized units of at least two principal perfluorinated monomers. Generally, one of the principal comonomers is a perfluoroolefin while the other is a perfluorovinyl ether. Representative perfluorinated olefins include tetrafluoroethylene and hexafluoropropylene. Suitable perfluorinated vinyl ethers include those of the formula

CF₂═CFO(R_{f′}-O)ₙ(R_{f″}-O)ₘR_{f} (I)

where R_{f′} and R_{f″} are different linear or branched perfluoroalkylene groups of 2-6 carbon atoms, m and n are independently 0-10, and R_{f} is a perfluoroalkyl group of 1-6 carbon atoms.

A preferred class of perfluorinated vinyl ethers includes compositions of the formula

CF₂═CFO(CF₂CFXO)ₙR_{f} (II)

where X is F or CF₃, n is 0-5, and R_{f} is a perfluoroalkyl group of 1-6 carbon atoms.

Most preferred perfluorinated vinyl ethers are those wherein n is 0 or 1 and R_{f} contains 1-3 carbon atoms. Examples of such perfluorinated ethers include perfluoro(methyl vinyl) ether and perfluoro(propyl vinyl) ether. Other useful monomers include compounds of the formula

CF₂═CFO[(CF₂)ₘCF₂CFZO]ₙR_{f} (III)

where R_{f} is a perfluoroalkyl group having 1-6 carbon atoms, m=0 or 1, n=0-5, and Z═F or CF₃. Preferred members of this class are those in which R_{f} is C₃F₇, m=0, and n=1. Additional perfluorinated vinyl ether monomers include compounds of the formula

CF₂═CFO[(CF₂CFCF₃O)ₙ(CF₂CF₂CF₂O)ₘ(CF₂)ₚ]CₓF₂ₓ₊₁ (IV)

where m and n=1-10, p=0-3, and x=1-5. Preferred members of this class include compounds where n=0-1, m=0-1, and x=1.

Additional examples of useful perfluorinated vinyl ethers include

CF₂═CFOCF₂CF(CF₃)O(CF₂O)ₘCₙF₂ₙ₊₁ (V)

where n=1-5, m=1-3, and where, preferably, n=1.

Preferred perfluoroelastomer copolymers are comprised of tetrafluoroethylene and at least one perfluorinated vinyl ether as principal monomer units. In such copolymers, the copolymerized perfluorinated ether units constitute from about 15-50 mole percent of total monomer units in the polymer.

The perfluoroelastomer further contains copolymerized units of at least one cure site monomer, generally in amounts of from 0.1-5 mole percent. The range is preferably between 0.3-1.5 mole percent. Although more than one type of cure site monomer may be present, most commonly one cure site monomer is used and it contains at least one nitrile substituent group. Suitable cure site monomers include nitrile-containing fluorinated olefins and nitrile-containing fluorinated vinyl ethers. Useful nitrile-containing cure site monomers include those of the formulas shown below.

CF₂═CF—O(CF₂)ₙ—CN (VI)

where n=2−12, preferably 2-6;

CF₂═CF—O[CF₂—CFCF₃—O]ₙ—CF₂—CFCF₃—CN (VII)

where n=0−4, preferably 0-2; and

CF₂═CF—[OCF₂CFCF₃]ₓ—O—(CF₂)ₙ—CN (VIII)

where x=1−2, and n=1−4.

Those of formula (VIII) are preferred. Especially preferred cure site monomers are perfluorinated polyethers having a nitrile group and a trifluorovinyl ether group. A most preferred cure site monomer is

CF₂═CFOCF₂CF(CF₃)OCF₂CF₂CN (IX)

i.e. perfluoro(8-cyano-5-methyl-3,6-dioxa-1-octene) or 8-CNVE.

Other cure site monomers include olefins represented by the formula R₁CH═CR₂R₃, wherein R₁ and R₂ are independently selected from hydrogen and fluorine and R₃ is independently selected from hydrogen, fluorine, alkyl, and perfluoroalkyl. The perfluoroalkyl group may contain up to about 12 carbon atoms. However, perfluoroalkyl groups of up to 4 carbon atoms are preferred. In addition, the cure site monomer preferably has no more than three hydrogen atoms. Examples of such olefins include ethylene, vinylidene fluoride, vinyl fluoride, trifluoroethylene, 1-hydropentafluoropropene, and 2-hydropentafluoropropene, as well as brominated or iodinated olefins such as 4-bromo-3,3,4,4-tetrafluorobutene-1 and bromotrifluoroethylene. Alternatively, or in addition to copolymerized units of cure site monomers, cure sites of bromine or iodine-containing end groups may be introduced onto the perfluoroelastomer polymer chain by the reaction of bromine or iodine-containing chain transfer agents during polymerization.

Another type of cure site monomer which may be incorporated in the perfluoroelastomers employed in this invention is perfluoro(2-phenoxypropyl vinyl ether) and related monomers as disclosed in U.S. Pat. No. 3,467,638.

An especially preferred perfluoroelastomer contains 53.0-79.9 mole percent tetrafluoroethylene, 20.0-46.9 mole percent perfluoro(methyl vinyl) ether and 0.1 to 1.5 mole percent nitrile-containing cure site monomer.

A preferred cure system, useful for perfluoroelastomers containing nitrile-containing cure sites, utilizes bis(aminophenols) and bis(aminothiophenols) of the formulas

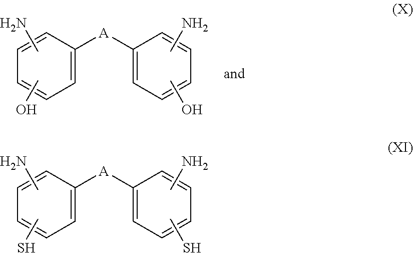

and tetraamines of the formula

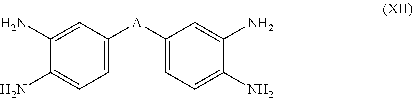

where A is SO₂, O, CO, alkyl of 1-6 carbon atoms, perfluoroalkyl of 1-10 carbon atoms, or a carbon-carbon bond linking the two aromatic rings. The amino and hydroxyl or thio groups in formulas X and XI above are adjacent to each other on the benzene rings and are interchangeably in the meta and para positions with respect to the group A. Preferably, the curing agent is a compound selected from the group consisting of 4,4′-[2,2,2-trifluoro-1-(trifluoromethypethylidene]bis(2-aminophenol); 4,4′-sulfonylbis(2-aminophenol); 3,3′-diaminobenzidine; and 3,3′,4,4′-tetraaminobenzophenone. The first of these is the most preferred and will be referred to as bis(aminophenol) AF. The curing agents can be prepared as disclosed in U.S. Pat. No. 3,332,907 to Angelo. Bis(aminophenol) AF can be prepared by nitration of 4,4′-[2,2,2-trifluoro-1-(trifluoromethyl)ethylidene]-bisphenol (i.e. bisphenol AF), preferably with potassium nitrate and trifluoroacetic acid, followed by catalytic hydrogenation, preferably with ethanol as a solvent and a catalytic amount of palladium on carbon as catalyst. The level of curing agent should be chosen to optimize the desired properties of the vulcanizate. In general, a slight excess of curing agent over the amount required to react with all the cure sites present in the perfluoroelastomer is used. Typically, 0.5-5.0 parts by weight of the curative per 100 parts of elastomer is required. The preferred range is 1.0-2.0 phr.

Peroxides may also be utilized as curing agents, particularly when the cure site is a nitrile group or an iodine or bromine group. Useful peroxides are those which generate free radicals at curing temperatures. A dialkyl peroxide or a bis(dialkyl peroxide) which decomposes at a temperature above 50° C. is especially preferred. In many cases it is preferred to use a ditertiarybutyl peroxide having a tertiary carbon atom attached to peroxy oxygen. Among the most useful peroxides of this type are 2,5-dimethyl-2,5-di(tertiarybutylperoxy)hexyne-3 and 2,5-dimethyl-2,5-di(tertiarybutylperoxy)hexane. Other peroxides can be selected from such compounds as dicumyl peroxide, dibenzoyl peroxide, tertiarybutyl perbenzoate, and di[1,3-dimethyl-3-(t-butylperoxy)butyl]carbonate. Generally, about 1-3 parts of peroxide per 100 parts of perfluoroelastomer is used. Another material which is usually blended with the composition as a part of the peroxide curative system is a coagent composed of a polyunsaturated compound which is capable of cooperating with the peroxide to provide a useful cure. These coagents can be added in an amount between 0.1 and 10 parts per 100 parts perfluoroelastomer, preferably between 2-5 phr. Typical coagents include, but are not limited to triallyl cyanurate; triallyl isocyanurate; tri(methylallyl)isocyanurate; tris(diallylamine)-s-triazine; triallyl phosphite; N,N-diallyl acrylamide; hexaallyl phosphoramide; N,N,N′,N′-tetraalkyl tetraphthalamide; N,N,N′,N′-tetraallylmalonamide; trivinyl isocyanurate; 2,4,6-trivinyl methyltrisiloxane; and tri(5-norbornene-2-methylene)cyanurate. Particularly useful is triallyl isocyanurate.

Other curatives suitable for vulcanizing perfluoroelastomers having nitrile cure sites include ammonia, the ammonium salts of inorganic or organic acids (e.g. ammonium perfluorooctanoate) as disclosed in U.S. Pat. No. 5,565,512, compounds (e.g. urea) which decompose to produce ammonia as disclosed in U.S. Pat. No. 6,281,296 B1 and nitrogen containing nucleophilic compounds (e.g. diphenylguanidine) as disclosed in U.S. Pat. No. 6,638,999 B2.

Depending on the cure site monomers present, it is also possible to use a dual cure system. For example, perfluoroelastomers having copolymerized units of nitrile-containing cure site monomers can be cured using a curative comprising a mixture of a peroxide in combination with an ammonia generator curative and a coagent. Generally, 0.3-5 parts of peroxide, 0.3-5 parts of coagent, and 0.1-10 parts of ammonia generator curative are utilized.

Additives, such as fillers (e.g. non-fibrillating and fibrillating fluoropolymers, non-conductive carbon black, barium sulfate, silica, aluminum oxide, aluminum silicate, and titanium dioxide), stabilizers, plasticizers, lubricants, and processing aids typically utilized in perfluoroelastomer compounding can be incorporated into the compositions of the present invention, provided they have adequate stability for the intended service conditions.

Cured perfluoroelastomer articles employed in this invention are made by shaping and then curing the above perfluoroelastomer compositions. Curing may be induced by heat or by radiation. The article may subsequently be post cured at elevated temperatures for a period of time. Examples of such articles include seals, gaskets, o-rings and composite parts (e.g. bonded door seals).

An aspect of this invention is a process for lowering the electrostatic potential of a perfluoroelastomer article that is free from conductive carbon black. The process comprises A) treating a perfluoroelastomer article with a reducing agent in order to reduce at least one surface of the perfluoroelastomer article; B) washing the treated perfluoroelastomer article to remove any excess reducing agent; and C) treating the washed, reduced perfluoroelastomer article with an ammonium hydroxide solution.

Examples of suitable reducing agents include, but are not limited to alkali metal naphthalides (e.g. sodium naphthalide, potassium naphthalide and sodium acenaphthylenide), liquid alkali metals (e.g. sodium/potassium alloy), and reducing plasmas (e.g. hydrogen plasma). Sodium naphthalide is a preferred reducing agent. It is typically in an organic solvent such as tetrahydrofuran or dimethoxyethane. FluoroEtch® (available from Acton Technologies) is an example of a commercially available reducing agent suitable for use in the process of this invention.

In step A) treatment preferably takes place in an inert atmosphere such as nitrogen or argon. Adequate reduction of the surface of the perfluoroelastomer article typically takes place at room temperature after exposure of the perfluoroelastomer article to the reducing agent for about 5 minutes.

In step B) the perfluoroelastomer article having a reduced surface is then washed to remove excess reducing agent. Washing does not need to be done in an inert atmosphere. Washing is typically a multi-step process wherein the reduced perfluoroelastomer article is first rinsed with an organic solvent (e.g. acetone), followed by deionized water and then a dilute acid solution (e.g. 0.1 M HCl). The article may then be rinsed with acetone again.

In step C) the washed and reduced perfluoroelastomer article is treated with an ammonium hydroxide solution (about 1 M) and allowed to air dry.

Preferably the perfluoroelastomer article is further washed with copious amounts of deionized water and preferably then with a final ammonium hydroxide solution in order to remove trace metal ions from the surface of the article.

The resulting perfluoroelastomer article having a reduced surface has a low electrostatic potential, i.e. less than 500V, preferably less than 100V and is especially suitable for use in semiconductor wafer manufacturing equipment. The surface of the article, to a depth of at least 10 microns, has a weight ratio of fluorine atoms to carbon atoms of 1.3:1 to 0.9:1 (preferably 1:1), as measured by ESCA. This is consistent with a plurality of C—C double bonds formed near the surface of the article due to action by the reducing agent. The article is free from conductive carbon black.

### EXAMPLES

### Test Methods

Electrostatic potential was measured on K314 size perfluoroelastomer o-rings in a Shishido Electrostatic Ltd., model STATIRON DS-3 electrostatic potential meter. The distance between the sensor and the o-ring was 5 mm. The average value of electrostatic potential, measured at 3 points along the o-ring surface, is reported in the Example.

ESCA surface analysis was carried out with a Physical Electronics Quantera Scanning ESCA Microprobe, using a focused (100 mm) monochromatic Al X-ray (1486.6 eV) beam operated at 20 kV and 100 W on treated and untreated (i.e. control) o-rings. The X-ray beam was generated using an electron gun and scanned over ˜1400 mm×˜200 mm to define the analysis area. Surface charging was neutralized by flooding the sample with low energy ions and electrons (˜8eV and ˜1 eV respectively). The electron energy analyzer was operated in the constant energy mode with a pass energy of 55 eV and 0.2 eV step size between data points for high resolution scans (typically 20-50 eV scan for each element). The take-off angle was 45° relative to the sample normal.

### Example 1

The perfluoroelastomer articles employed in this Example were type K-314 o-rings made from a perfluoroelastomer comprising copolymerized units of tetrafluoroethylene, perfluoro(methyl vinyl)ether and perfluoro(8-cyano-5-methyl-3,6-dioxa-1-octene) that had been cured with bis(aminophenol) AF. The o-rings were free from conductive carbon black.

The electrostatic potential of an o-ring was measured prior to treating as 1085V. ESCA showed the weight ratio of fluorine atoms to carbon atoms as 1.8:1 prior to treatment.

O-rings to be treated by the process of the invention were placed in a nitrogen purgebox. O-rings were then treated with a solution of sodium naphthalide in dimethoxyethane (FluoroEtch®). The samples were gently agitated to ensure adequate coverage. After 5 minutes, the o-rings were removed from the green solution and transferred out of the purgebox. The reduced surface o-rings were then washed with acetone, followed by deionized water, then 0.1M HCl and finally acetone again. The electrostatic potential of an o-ring was measured as 399V at this stage of the process.

Washed o-rings were then dipped into a 1M ammonium hydroxide solution and allowed to air dry. O-rings were then subjected to washing in copious amounts of deionized water. The electrostatic potential on a resulting o-ring was measured as 52V. ESCA showed the weight ratio of fluorine atoms to carbon atoms as 0.98:1 on a resulting o-ring.

What is claimed is:

1. A process for reducing the electrostatic potential of a perfluoroelastomer article, said process comprising:
A) treating a perfluoroelastomer article with a reducing agent in order to reduce at least one surface of the perfluoroelastomer article;
B) washing the treated perfluoroelastomer article to remove any excess reducing agent; and
C) treating the washed, treated perfluoroelastomer article with an ammonium hydroxide solution.

2. The process of claim 1 wherein said reducing agent is selected from the group consisting of alkali metal naphthalides, liquid alkali metals, and reducing plasmas.

3. The process of claim 2 wherein said alkali metal naphthalide is selected from the group consisting of sodium naphthalide, potassium naphthalide and sodium acenaphthylenide.

4. The process of claim 3 wherein said alkali metal naphthalide is sodium naphthalide.

5. The process of claim 4 wherein said sodium naphthalide is a solution in an organic solvent.

6. An article comprising a cured perfluoroelastomer, said article having an electrostatic potential less than 500V and a weight ratio of fluorine atoms to carbon atoms of 1.3:1 to 0.9:1, as measured by ESCA, and wherein said article is free from conductive carbon black.

7. The article of claim 6 wherein said electrostatic potential is less than 100V.

8. The article of claim 6 wherein said weight ratio of fluorine atoms to carbon atoms is 1:1.
